(19) United States
(12) Patent Application Publication
(10) Pub. No.: US 2026/0224330 A1
(43) Pub. Date: Aug. 6, 2026

(54) ACCESSORY WITH CUSTOM BASE FOR DENTAL MOVEMENT

(71) Applicant: Aliwell SAPI de CV, San Pedro Garza Garcia (MX)

(72) Inventors: Roberto Carrillo Fuentevilla, San Pedro Garza Garcia (MX); Roberto Carrillo Gonzalez, San Pedro Garza Garcia (MX)

(21) Appl. No.: 19/377,780

(22) Filed: Nov. 3, 2025

Related U.S. Application Data
(60) Provisional application No. 63/715,607, filed on Nov. 3, 2024.

(51) Int. Cl. A61C 7/08; A61C 7/00

(52) U.S. Cl. CPC A61C 7/08; A61C 7/002

(57) ABSTRACT

An accessory and a base chamber for transmitting forces to a tooth are disclosed. The base chamber is formed in a material bonded to a surface of the tooth and is dimensioned to receive at least a portion of a retention portion of the accessory. The accessory is configured to receive forces and transmit the forces to the tooth along one or more force vector directions determined from a planned virtual setup. A method is disclosed that includes obtaining a three-dimensional digital model of a patient dentition, defining a planned virtual setup, determining force vector directions associated with at least one desired end position of a tooth, determining a candidate base chamber geometry based on a geometry of a retention portion of the accessory, and outputting digital data representing the base chamber geometry. A computer program product is disclosed to cause a computing system to perform the method.

### CROSS-REFERENCE TO RELATED APPLICATIONS

This Application claims the benefit of U.S. Provisional Application Ser. No. 63/715,607, filed Nov. 3, 2024, which is hereby incorporated by reference for all purposes.

### BACKGROUND

Orthodontic treatment methods aim to achieve precise dental corrections through the application of controlled mechanical forces. Traditional appliances, such as brackets and wires, are commonly used to exert pressure on individual teeth or groups of teeth to move them into desired positions. More recently, clear aligners have gained popularity due to their aesthetic appeal and removability. These aligners can incorporate attachments that help deliver specific forces; however, their effectiveness can be limited by how well these attachments engage with the tooth and transfer force.

Attachments for clear aligners are typically fabricated as composite resin shapes bonded to the tooth surface. These attachments rely on being enclosed within the aligner's plastic to transfer force properly. This can result in challenges related to the predictability of movement, especially in cases where greater control is required to move teeth in three dimensions or when attempting to apply force at specific angles or locations on a tooth. The reliance on these simple shapes can sometimes lead to suboptimal outcomes when more complex movements are needed, due to limitations in force application precision.

Various accessories, such as power arms and additional wire components, have been used alongside aligners or traditional braces to augment the control of orthodontic forces. These components are often adapted or custom-made for each patient to address specific biomechanical needs. Despite these efforts, prior art has struggled to ensure consistent integration and retention of these accessories in treatment plans without compromising patient comfort or requiring extensive customization. Methods to create stable yet adaptable interfaces between the accessory and the tooth remain a challenge, particularly when attempting to distribute force efficiently and effectively for optimal tooth movement.

### SUMMARY

Disclosed herein is an accessory and a base chamber formed in a material bonded to a surface of a tooth. The accessory includes a retention portion, and at least a portion of the retention portion is positioned within the base chamber. The accessory is configured to receive forces for transmission to the tooth along one or more force vector directions determined from a planned virtual setup. The base chamber is dimensioned to receive the retention portion and is formed based on digital planning of the planned virtual setup.

Further disclosed herein is a method carried out in a computing system. A three-dimensional digital model of a patient dentition may be obtained, a planned virtual setup may be defined, force vector directions may be determined, and a base chamber may be digitally generated at a planned location on a tooth. Digital data representing the base chamber geometry may be output for physical fabrication.

Further disclosed herein is a computer program product comprising program instructions stored on a non-transitory computer readable storage medium that, when executed by one or more processors, cause the computing system to perform a method corresponding to the method described herein.

Other aspects of the invention will be apparent from the following description and the appended claims.

### BRIEF DESCRIPTION OF DRAWINGS

FIG. 1A illustrates an accessory including a head portion, a body portion, and a retention portion.

FIG. 1B illustrates a base chamber formed in a material bonded to a surface of a tooth.

FIG. 1C illustrates the accessory positioned relative to the base chamber.

FIG. 2A illustrates an assembly including an accessory positioned in a base chamber.

FIG. 2B illustrates an assembly including an accessory positioned in a base chamber.

FIG. 2C illustrates an assembly including an accessory positioned in a base chamber.

FIG. 3A illustrates an assembly including the accessory and base chamber.

FIG. 3B illustrates an assembly including the accessory and base chamber.

FIG. 4A illustrates a base chamber on a tooth surface.

FIG. 4B illustrates a base chamber on a tooth surface.

FIG. 5A illustrates a base chamber and an accessory.

FIG. 5B illustrates a base chamber and an accessory.

FIG. 6A illustrates a base chamber and an accessory.

FIG. 6B illustrates a base chamber and an accessory.

FIG. 7A illustrates an accessory positioned at a first height within a base chamber.

FIG. 7B illustrates the accessory positioned at a second height.

FIG. 7C illustrates the accessory positioned at a third height.

FIG. 8A illustrates an accessory positioned at a first angle within a base chamber.

FIG. 8B illustrates the accessory positioned at a second angle without changing the base chamber direction.

FIG. 9A illustrates a base chamber at a first angle and position relative to the tooth.

FIG. 9B illustrates a base chamber at a second angle and position relative to the tooth.

FIG. 10A illustrates forces applied to an accessory from a skeletal anchorage device.

FIG. 10B illustrates forces applied to an accessory from a clear aligner.

FIG. 10C illustrates forces applied from an accessory to another tooth.

FIG. 11A-11D illustrate an example where a clear aligner blocks insertion of the accessory into a closed chamber.

FIG. 12 and FIG. 12A-12C illustrate a base chamber that extends past the gingival margin to create an opening corresponding to the insertion path of the accessory.

FIG. 13 and FIGS. 13A and 13B show a computing system in accordance with one or more embodiments of the invention.

Like elements in the various figures are denoted by like reference numerals for consistency.

### DETAILED DESCRIPTION

As used herein, the term “virtual setup” means a planned representation of desired end positions of teeth within a three-dimensional digital model of a patient dentition.

As used herein, the term “force vector direction” means a geometric direction in three-dimensional space associated with the transmission of orthodontic forces derived from the planned virtual setup.

As used herein, the term “base chamber” means a physical chamber formed in a material bonded to a surface of a tooth that is dimensioned to receive at least a portion of a retention portion of an accessory, and that can optionally include an opening through which the retention portion is insertable.

As used herein, the term “accessory” means a structure having at least a retention portion configured to be positioned within a base chamber and that is configured to receive orthodontic forces for transmission to a tooth along one or more force vector directions derived from the planned virtual setup, wherein the accessory may optionally be removable and re-insertable with respect to the base chamber.

In general, embodiments are directed to an accessory with a custom base designed to enhance orthodontic treatments, particularly in conjunction with clear aligners to an accessory, such as a power arm, is securely held in a specially constructed through mechanical or chemical bonding. The chamber serves as a base for the accessory, allowing the application of forces in precise directions and at various points on the tooth or associated structures. Force application can be tailored to the specific biomechanical needs of the patient, improving the predictability and effectiveness of tooth movement.

A customizable chamber template facilitates the creation of the base on the tooth surface. The template is designed to hold the shape of the base while it is filled with a flowable composite material, which is then light-cured or chemically hardened. This approach allows for controlled placement of the accessory with an open side for insertion, addressing limitations seen in traditional attachments that fully encase the tooth.

Positioning of the chamber can be planned in three-dimensional space, enabling adjustments to the angle and placement of the accessory to better align with patient-specific treatment plans. Chamber and accessory configurations are modeled digitally, providing enhanced accuracy before fabrication. This method enables the integration of various accessory shapes and materials that can withstand the applied orthodontic forces. As a result, greater customization and enhanced mechanical stability can be achieved during treatment, providing practitioners with more precise control over complex tooth movements.

The embodiments disclosed herein may be implemented using one or more computing systems configured to display, modify, and store three-dimensional digital models of patient dentitions. A digital workflow is used to generate a planned virtual setup, determine force vector directions associated with desired end positions of teeth, and generate base chamber geometry at specific tooth locations to accommodate accessories for transmitting forces to corresponding teeth.

The computing system may receive a digital scan of the patient dentition and generate a three-dimensional digital model of the dentition. The clinician and/or the computing system may identify one or more teeth for which an accessory will be beneficial to transmit forces along one or more force vector directions determined from the planned virtual setup. In at least some embodiments, the computing system may propose candidate tooth surfaces for base chamber placement based on the force vector directions. In other embodiments, the clinician may manually select tooth surfaces for base chamber placement. In either case, the clinician may override any automated selection by the computing system.

The computing system may define a base chamber geometry in the digital model at each selected tooth surface. The chamber geometry is dimensioned to receive at least a portion of a retention portion of an accessory. The base chamber geometry is then output from the computing system as digital data for physical fabrication. The digital data may be used to fabricate one or more templates, tool paths, molds, guides, or other structures configured to produce a physical base chamber on the corresponding tooth surface. When the base chamber is formed on the tooth surface, at least a portion of the retention portion of the accessory may be positioned within the base chamber.

Accessories described herein may be removable after treatment begins and may be re-inserted into the base chamber as needed. In at least some embodiments, multiple accessories may be used on one or more teeth to apply forces along multiple force vector directions derived from the planned virtual setup.

The accessory includes a retention portion configured to be positioned within a base chamber formed in a material bonded to a tooth surface. In at least some embodiments, the accessory also includes a head portion positioned at one end of the accessory and a body portion extending between the head portion and the retention portion. The body portion may extend in any direction relative to the tooth surface and is not limited to a linear or planar configuration. The head portion may be used to receive or interface with a force generating medium. The specific shape of the head portion and body portion may be selected based on the force vector directions determined from the planned virtual setup.

The accessory may be formed from one or more biocompatible materials having sufficient structural rigidity to receive and transmit orthodontic forces. Examples of acceptable materials include metals, printed resins, or other compositions capable of being formed, molded, machined, printed, or otherwise shaped to obtain the desired geometry. In at least some embodiments, the accessory may be produced by three-dimensional additive manufacturing.

The retention portion includes one or more structures that facilitate mechanical, chemical, or mechanical-and-chemical retention within the base chamber. In at least some embodiments, the retention portion may include surface topographies such as ridges, grooves, perforations, twists, or other structures. In other embodiments, the retention portion may include surface chemistry or bonding features configured to interact with the material forming the base chamber.

The accessory may be sized and configured such that only a portion of the retention portion is inserted within the base chamber. In at least some embodiments, the accessory may be removable and re-insertable into the base chamber. In other embodiments, the accessory may be permanently retained within the base chamber.

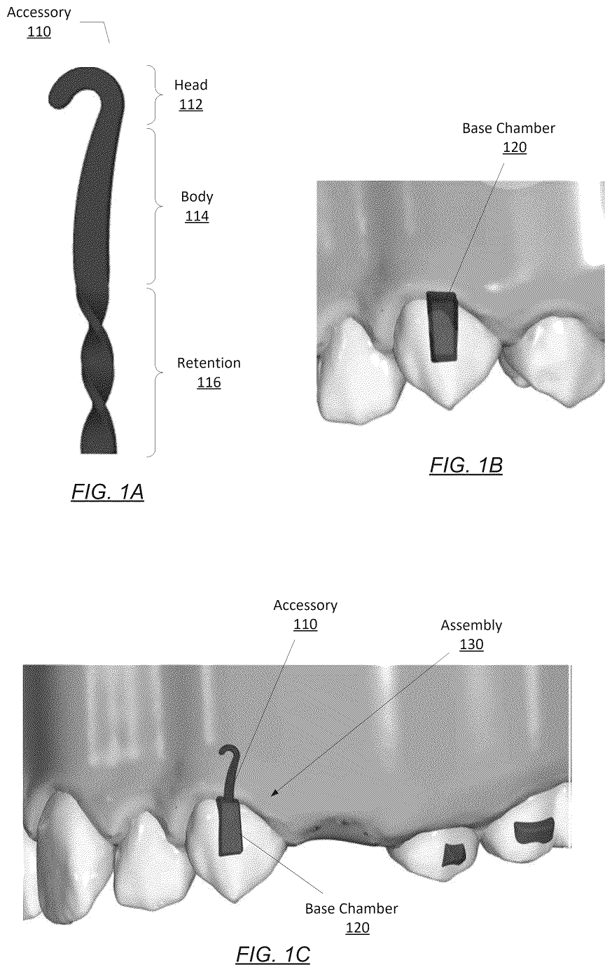

FIG. 1A shows an accessory (110) including a head (112), a body (114), and a retention portion (116). The body (114) extends between the head (112) and the retention portion (116). The head (112) is positioned at an end of the body (114). The retention portion (116) is positioned at another end of the body (114). The retention portion (116) is configured to be positioned in a base chamber formed on a tooth surface. The head (112) is configured to receive forces for transmission to the tooth along one or more force vector directions determined from a planned virtual setup.

FIG. 1B shows a base chamber (120) formed in a material bonded to a surface of a tooth. The base chamber (120) is dimensioned to receive at least a portion of the retention portion (116) of the accessory (110). The geometry of the base chamber (120) corresponds to a location determined from a planned virtual setup.

FIG. 1C shows the accessory (110) positioned relative to the base chamber (120) to form an assembly (130). At least a portion of the retention portion (116) of the accessory (110) is positioned within the base chamber (120). The assembly (130) is configured to transmit forces along one or more force vector directions determined from the planned virtual setup.

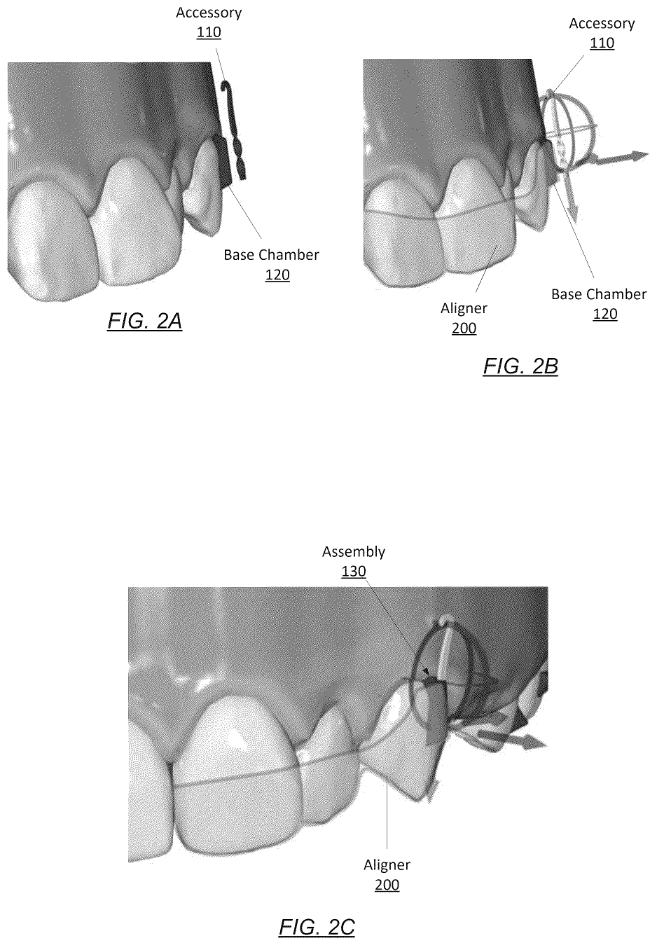

FIG. 2A shows an assembly (130) including the accessory (110) positioned within the base chamber (120) and an aligner (200) positioned adjacent to the tooth surface. The aligner (200) may apply forces to the assembly (130) based on the planned virtual setup. The assembly (130) may transmit forces to the tooth along one or more force vector directions determined from the planned virtual setup.

FIG. 2B shows the assembly (130) including the accessory (110) positioned in the base chamber (120) when the aligner (200) is seated on the patient dentition. The aligner (200) may apply forces to the accessory when the aligner (200) is fully seated. The assembly (130) may receive these forces and transmit them to the corresponding tooth.

FIG. 2C shows the assembly (130) including the accessory (110) positioned in the base chamber (120) when the aligner (200) is seated and applying forces. The aligner (200) may include force application features based on the planned virtual setup. The assembly (130) may transmit the forces applied by the aligner (200) to the tooth along one or more force vector directions determined from the planned virtual setup.

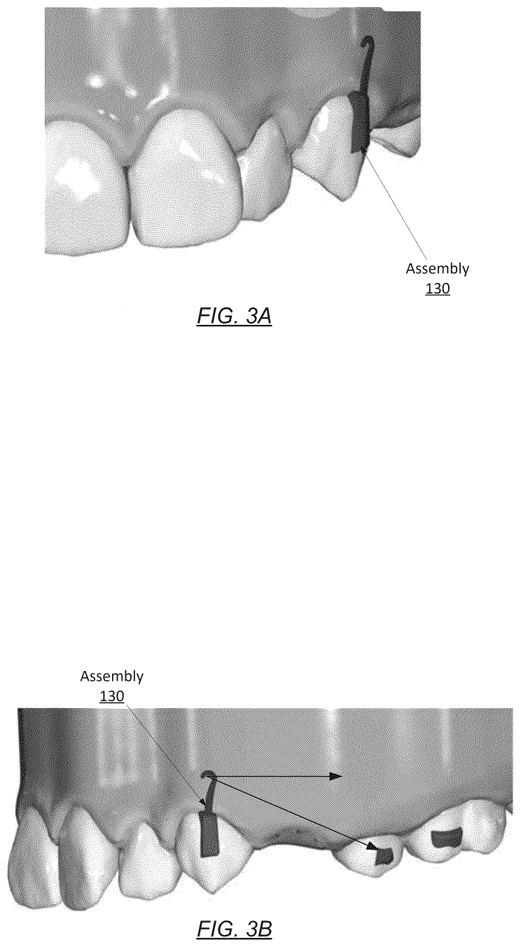

FIG. 3A shows an assembly (130) including the accessory (110) positioned within the base chamber (120) after the base chamber (120) has been formed on the tooth surface. The accessory (110) and the base chamber (120) may be joined together through mechanical retention, chemical retention, or both mechanical and chemical retention. The combined structure functions as a single piece component.

FIG. 3B shows that forces may be applied to the accessory (110) in multiple directions. The accessory (110) may receive forces from one or more external structures, and those forces may be transmitted to the assembly (130). The external structures may include anchor structures, orthodontic appliance structures, another tooth, another accessory, or other force generating or force receiving elements. The assembly (130) may transmit the received forces to the tooth along one or more force vector directions determined from the planned virtual setup.

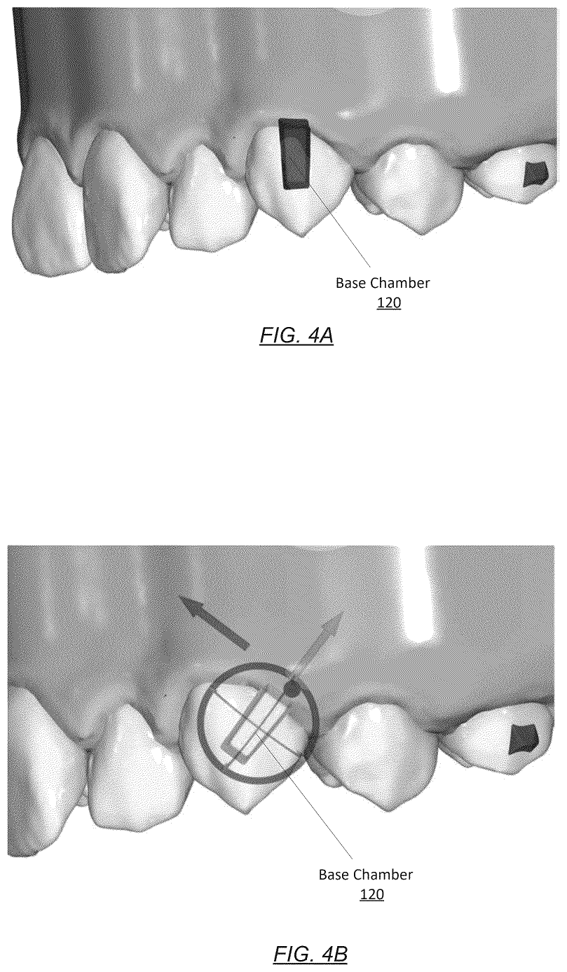

FIG. 4A shows a base chamber (120) formed in a material bonded to a surface of a tooth at a first angulation relative to the tooth surface. The angulation of the base chamber (120) corresponds to a first set of force vector directions determined from the planned virtual setup.

FIG. 4B shows a base chamber (120) formed in a material bonded to a surface of a tooth at a second angulation relative to the tooth surface. The second angulation of the base chamber (120) corresponds to a second set of force vector directions determined from the planned virtual setup. The angulation may be changed to align the accessory with desired force vector directions derived from the planned virtual setup.

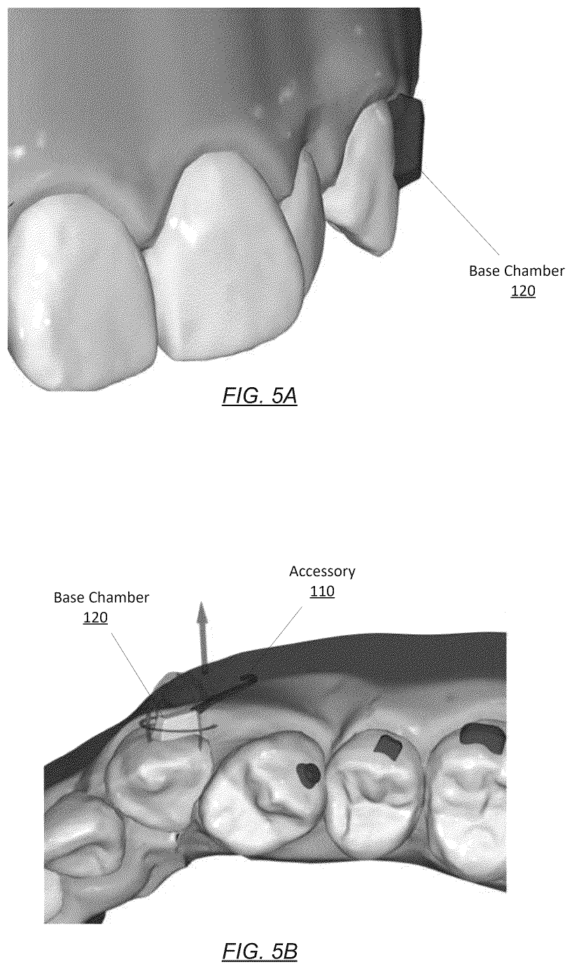

FIG. 5A shows a base chamber (120) formed in a material bonded to a surface of a tooth. The thickness and shape of the base chamber (120) correspond to the shape, size, and thickness of the accessory (110) to be positioned within the base chamber (120). The thickness of the base chamber (120) may be selected to match the retention portion geometry of the accessory (110).

FIG. 5B shows a base chamber (120) formed in a material bonded to a surface of a tooth with a different thickness and shape relative to FIG. 5A. The different thickness and shape of the base chamber (120) correspond to a different accessory geometry. The thickness and shape of the base chamber (120) may be varied to accommodate different accessory geometries.

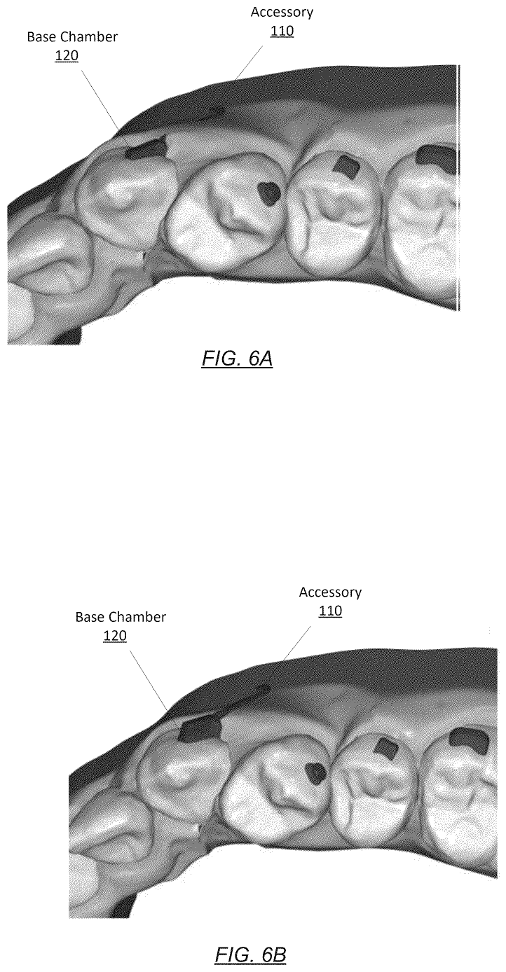

FIG. 6A shows a base chamber (120) formed in a material bonded to a surface of a tooth at a first spatial position in three-dimensional space relative to the tooth. The spatial position of the base chamber (120) may be selected to avoid impingement with adjacent tissue and to align the accessory (110) with planned force vector directions determined from the planned virtual setup.

FIG. 6B shows a base chamber (120) formed in a material bonded to a surface of a tooth at a second spatial position in three-dimensional space relative to the tooth. The spatial position of the base chamber (120) may be changed to satisfy biomechanical requirements and to avoid tissue impingement. The base chamber (120) may be positioned within the digital model in any of the three planes of space.

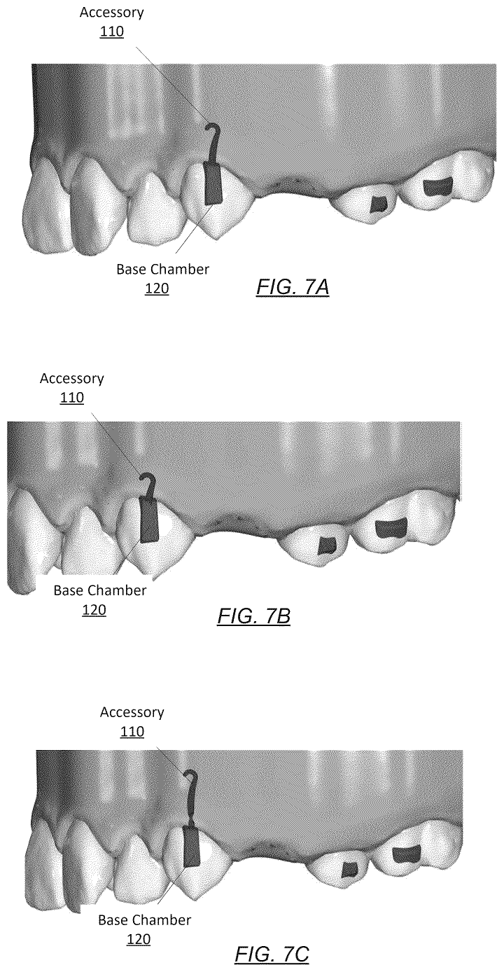

FIG. 7A shows a base chamber (120) formed in a material bonded to a surface of a tooth and the accessory (110) positioned within the base chamber (120) at a first height. The height at which the retention portion of the accessory (110) is positioned within the base chamber (120) may be selected based on biomechanical requirements of the planned virtual setup.

FIG. 7B shows the same base chamber (120) with the accessory (110) positioned at a second height within the base chamber (120). The second height is different from the height shown in FIG. 7A. The height selected may be adjusted to align the accessory (110) with force vector directions determined from the planned virtual setup.

FIG. 7C shows the same base chamber (120) with the accessory (110) positioned at a third height within the base chamber (120). The accessory (110) may be positioned at multiple potential heights depending on the needs of the patient. The height positioning of the accessory (110) within the base chamber (120) may be used to align the accessory (110) with planned force vector directions.

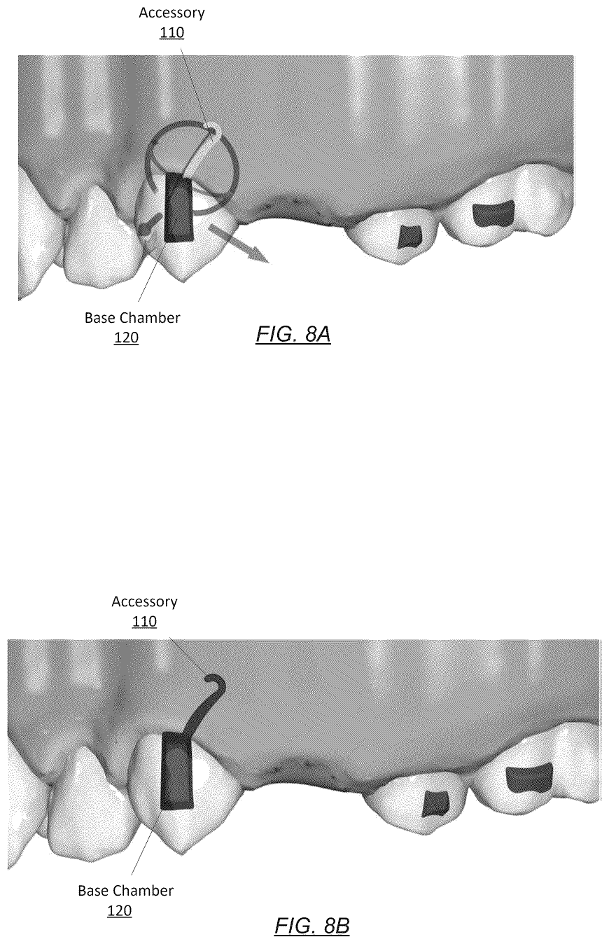

FIG. 8A shows a base chamber (120) formed in a material bonded to a surface of a tooth with the accessory (110) positioned within the base chamber (120) at a first angle relative to the base chamber (120). The angle of the accessory (110) may be selected to align the accessory (110) with force vector directions determined from the planned virtual setup.

FIG. 8B shows the same base chamber (120) with the accessory (110) positioned within the base chamber (120) at a second angle relative to the base chamber (120). The direction of the base chamber (120) is unchanged between FIG. 8A and FIG. 8B. The angle and position of the accessory (110) within the base chamber (120) may be modified independently of the direction of the base chamber (120) to best fit the patient's biomechanical needs.

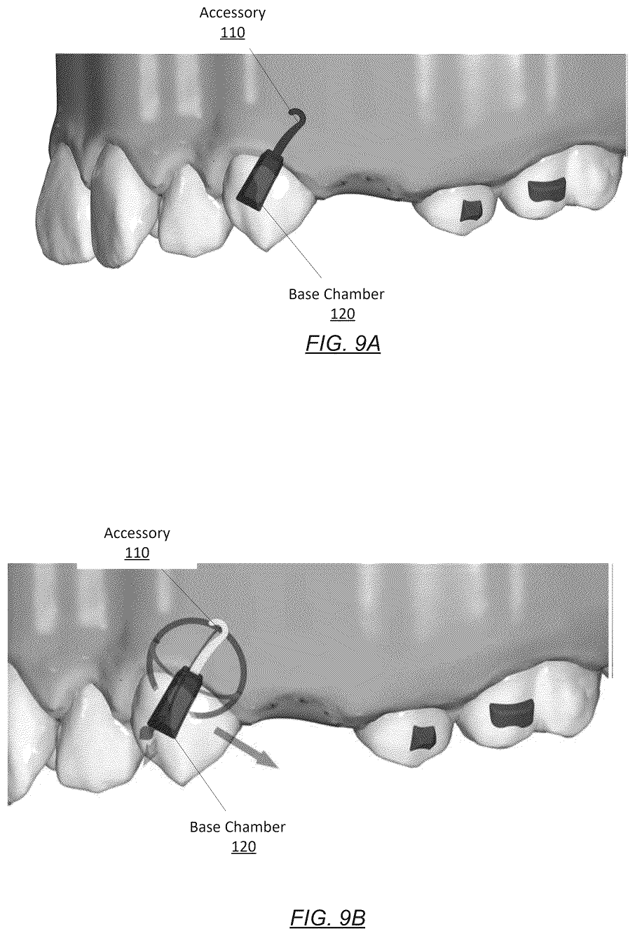

FIG. 9A shows a base chamber (120) formed in a material bonded to a surface of a tooth at a first angle and position relative to the tooth surface, with the accessory (110) positioned for insertion into the base chamber (120). The angle and position of the base chamber (120) may be selected to align the base chamber (120) with the angle of the accessory (110).

FIG. 9B shows a base chamber (120) formed in a material bonded to a surface of a tooth at a second angle and position relative to the tooth surface, with the accessory (110) positioned for insertion into the base chamber (120). The angle and position of the base chamber (120) may be changed to correspond to the angle of the accessory (110) to be embedded in the base chamber (120) when formed in the material bonded to the tooth.

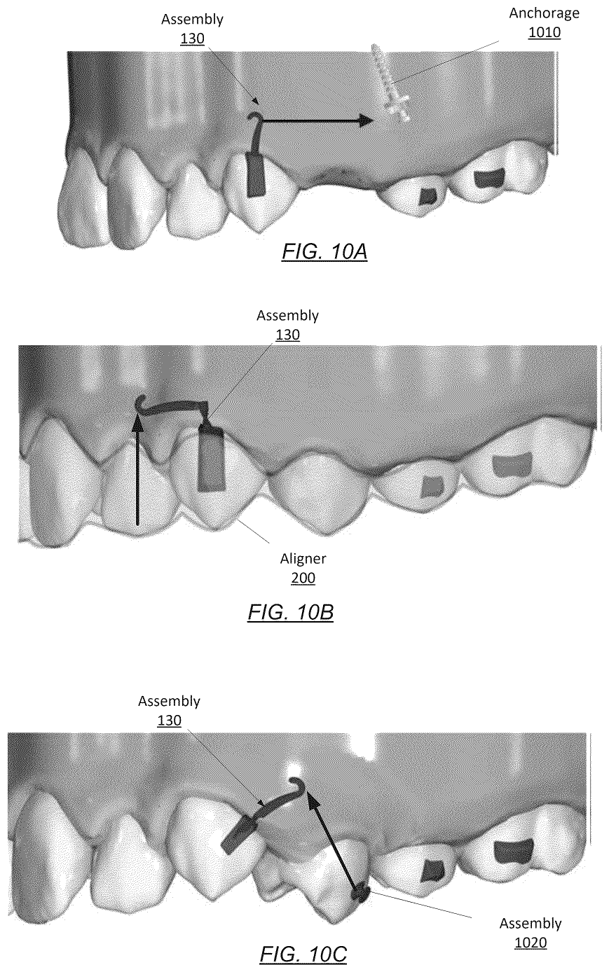

FIG. 10A shows an assembly (130) including the accessory (110) positioned in the base chamber (120) and applying forces directly to an anchoring structure. The anchoring structure may include a skeletal anchorage device. The assembly (130) may transmit forces to the tooth where the base chamber (120) is formed based on the planned virtual setup.

FIG. 10B shows an assembly (130) including the accessory (110) positioned in the base chamber (120) and applying forces to an orthodontic appliance. The orthodontic appliance may include a clear aligner. The assembly (130) may transmit forces received from the orthodontic appliance to the tooth based on the planned virtual setup.

FIG. 10C shows an assembly (130) including the accessory (110) positioned in the base chamber (120) and applying forces to another tooth. The forces may be transmitted to the other tooth through another accessory positioned on that other tooth. The assembly (130) may apply forces more efficiently by being positioned closer to a center of resistance of the tooth to be moved.

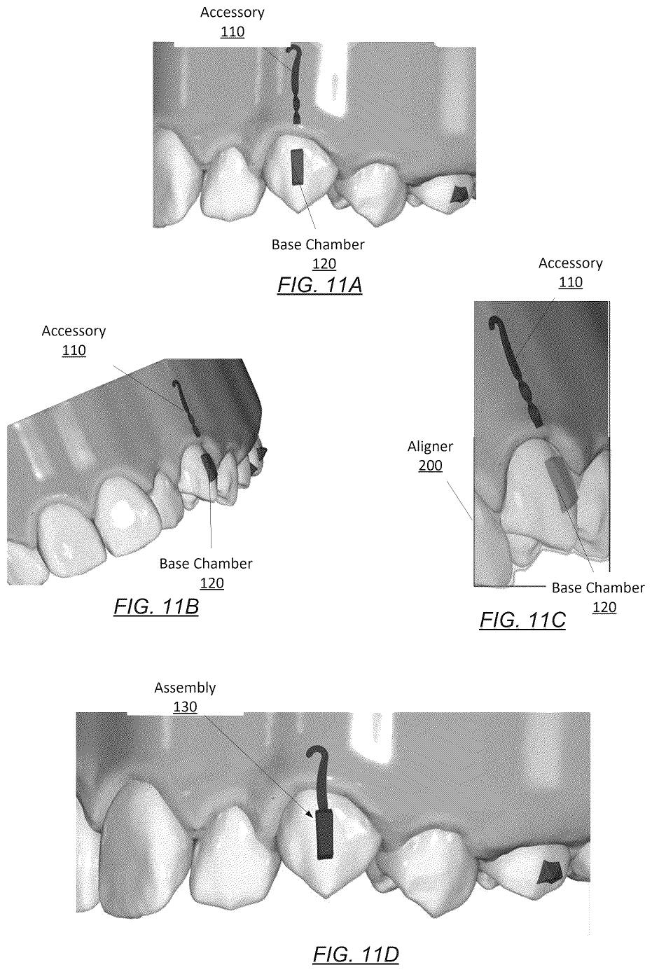

FIG. 11A shows an assembly (130) including a base chamber (120) that is shaped like a conventional clear aligner attachment. When the aligner plastic is seated, the top portion of the chamber is blocked.

FIG. 11B shows an assembly (130) where the clear aligner covers the chamber on all sides, including the occlusal region. When the chamber is enclosed by the aligner, the retention portion of the accessory (110) cannot be inserted.

FIG. 11C shows that conventional clear aligner attachments require full plastic coverage on all sides to apply force directly to the tooth. Clear aligner attachments are designed to be surrounded on all sides by plastic.

FIG. 11D shows that if the base chamber (120) is shaped like a clear aligner attachment, the aligner blocks the insertion path, and the accessory (110) cannot be inserted. The base chamber used with the accessory must include an opening that is not blocked by the aligner.

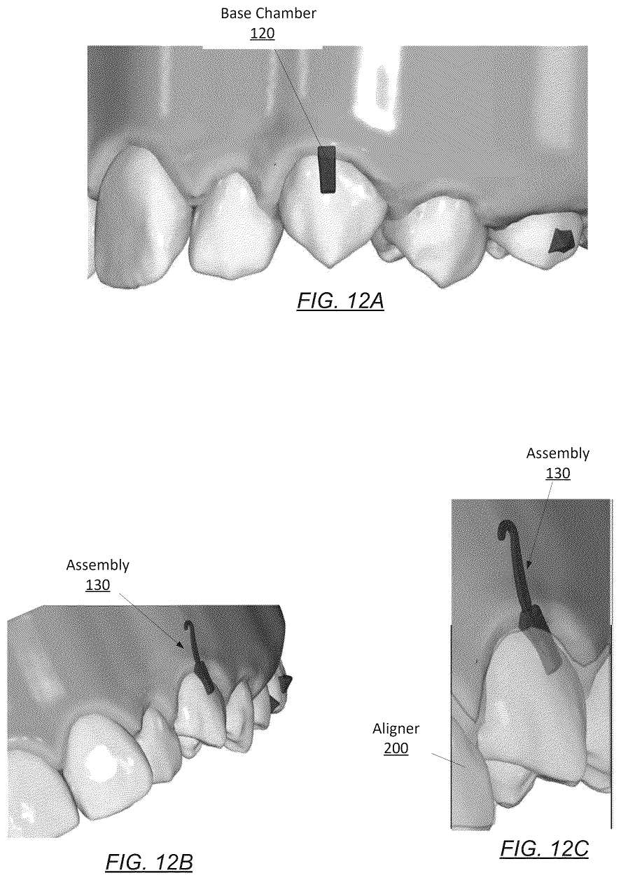

FIG. 12 shows a base chamber (120) planned digitally such that the base chamber (120) extends past the gingival margin. When the base chamber (120) extends past the gingival margin, the template trimline creates an opening to allow insertion of the accessory (110) during the bonding procedure.

FIG. 12A shows that when the digital base chamber (120) extends past the gingival margin, the template used to form the base chamber (120) will include an opening on the gingival side. The opening allows the accessory (110) to be inserted into the composite material while the template is in place.

FIG. 12B shows that when the base chamber (120) is filled clinically, only the portion of the chamber that is inside the template is filled with composite material. The composite material is then hardened to hold the accessory (110) in the base chamber (120).

FIG. 12C shows that the base chamber (120) is not filled to 100% of the original digital volume. Only the portion of the base chamber (120) that is maintained by the template defines the final physical shape and size of the base chamber (120). This allows the accessory (110) to be inserted and positioned as required.

### Method Description—Digital Staging and Base Chamber Generation

A three-dimensional digital model of the patient dentition may be obtained. The digital model may be derived from one or more intraoral scans or other digitizing modalities. A planned virtual setup may be defined within the digital model to represent desired end positions of teeth. The planned virtual setup may also define the force vector directions associated with the desired end positions.

The computing system may determine at least one force vector direction that is associated with at least one desired end position of a tooth. The computing system may determine a candidate region on the tooth surface for placement of a base chamber. The computing system may determine candidate geometry for the base chamber based on the retention portion of the accessory. The candidate geometry may include chamber shape, chamber thickness, and chamber angulation.

The computing system may permit the clinician to modify the position, shape, thickness, and angulation of the base chamber within the digital model. The clinician may modify any chamber parameter while viewing the planned virtual setup. The computing system may also permit the clinician to modify the position, height, angulation, and orientation of the accessory within the chamber geometry.

The computing system may generate the base chamber geometry in the digital model based on the adjustments selected by the clinician. The digital data representing the base chamber geometry may be output to a fabrication system. The fabrication system may produce a physical structure used clinically to form the base chamber on the patient tooth surface. The accessory may then be positioned within the base chamber after the base chamber has been formed.

### Optional Clinical Implementation Detail

A physical template may be fabricated based on the digital base chamber geometry. The physical template may include an opening that corresponds to the opening of the digital base chamber geometry. The physical template may be placed over the patient tooth surface. A curable material may be applied to the tooth surface through the physical template to form the base chamber in the physical material bonded to the tooth. The curable material may be a composite resin or other material capable of being hardened to form a base chamber.

The accessory may be inserted into the base chamber material while the material remains in an uncured or partially uncured state. The curable material may then be hardened to hold the accessory in the base chamber. The curable material may be applied only to the portion of the chamber contained within the template. The final physical shape and size of the base chamber may therefore be defined by the portion of the template that overlies the tooth.

The accessory may be removable from the base chamber after the material is cured. The accessory may be re-insertable into the base chamber if desired. In other embodiments, the accessory may be permanently retained.

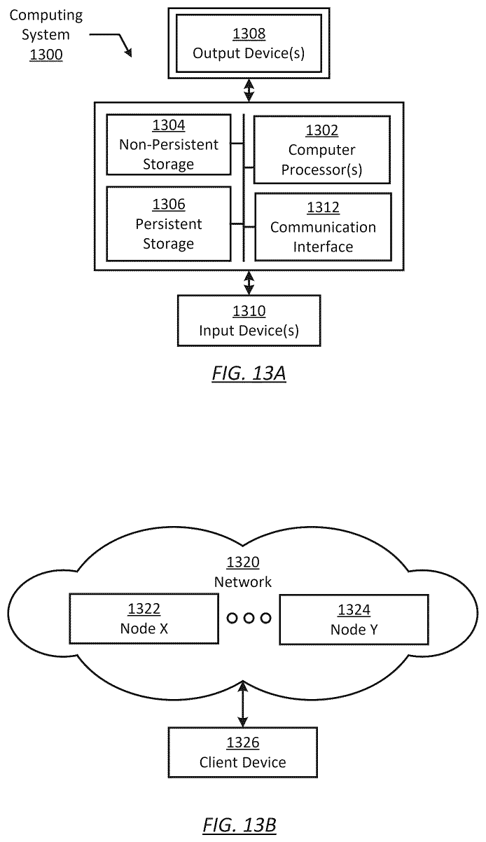

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 13A, the computing system (1300) may include one or more computer processors (1302), non-persistent storage (1304), persistent storage (1306), a communication interface (1312) (e.g., Bluetooth interface, infrared interface, network interface, optical interface, etc.), and numerous other elements and functionalities that implement the features and elements of the disclosure. The computer processor(s) (1302) may be an integrated circuit for processing instructions. The computer processor(s) may be one or more cores or micro-cores of a processor. The computer processor(s) (1302) includes one or more processors. The one or more processors may include a central processing unit (CPU), a graphics processing unit (GPU), a tensor processing units (TPU), combinations thereof, etc.

The input devices (1310) may include a touchscreen, keyboard, mouse, microphone, touchpad, electronic pen, or any other type of input device. The input devices (1310) may receive inputs from a user that are responsive to data and messages presented by the output devices (1308). The inputs may include text input, audio input, video input, etc., which may be processed and transmitted by the computing system (1300) in accordance with the disclosure. The communication interface (1312) may include an integrated circuit for connecting the computing system (1300) to a network (not shown) (e.g., a local area network (LAN), a wide area network (WAN) such as the Internet, mobile network, or any other type of network) and/or to another device, such as another computing device.

Further, the output devices (1308) may include a display device, a printer, external storage, or any other output device. One or more of the output devices may be the same or different from the input device(s). The input and output device(s) may be locally or remotely connected to the computer processor(s) (1302). Many different types of computing systems exist, and the aforementioned input and output device(s) may take other forms. The output devices (1308) may display data and messages that are transmitted and received by the computing system (1300). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (1300) in FIG. 13A may be connected to or be a part of a network. For example, as shown in FIG. 13B, the network (1320) may include multiple nodes (e.g., node X (1322), node Y (1324)). Each node may correspond to a computing system, such as the computing system shown in FIG. 13A, or a group of nodes combined may correspond to the computing system shown in FIG. 13A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1300) may be located at a remote location and connected to the other elements over a network.

The nodes (e.g., node X (1322), node Y (1324)) in the network (1320) may be configured to provide services for a client device (1326), including receiving requests and transmitting responses to the client device (1326). For example, the nodes may be part of a cloud computing system. The client device (1326) may be a computing system, such as the computing system shown in FIG. 13A. Further, the client device (1326) may include and/or perform all or a portion of one or more embodiments of the invention.

The computing system of FIG. 13A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. An apparatus comprising:
an accessory including a retention portion; and
a base chamber formed in a material bonded to a surface of a tooth, the base chamber dimensioned to receive at least a portion of the retention portion;
wherein the accessory is configured to receive forces for transmission to the tooth along one or more force vector directions determined from a planned virtual setup.

2. The apparatus of claim 1, wherein the body of the accessory extends between a head and the retention portion.

3. The apparatus of claim 1, wherein the head of the accessory is configured to interface with a force generating medium.

4. The apparatus of claim 1, wherein the retention portion comprises a surface topography.

5. The apparatus of claim 1, wherein the accessory is removable from the base chamber.

6. The apparatus of claim 1, wherein the accessory is re-insertable into the base chamber.

7. The apparatus of claim 1, wherein the base chamber has a thickness determined from a geometry of the retention portion.

8. The apparatus of claim 1, wherein the base chamber has a thickness determined from a geometry of the head of the accessory.

9. The apparatus of claim 1, wherein the base chamber is formed to include an opening corresponding to an insertion path of the accessory.

10. The apparatus of claim 1, wherein the accessory is configured to receive forces from a skeletal anchorage device.

11. The apparatus of claim 1, wherein the accessory is configured to receive forces from an aligner.

12. The apparatus of claim 1, wherein the accessory is configured to receive forces from another accessory located on another tooth.

13. A method comprising:
obtaining a three-dimensional digital model of a patient dentition;
defining a planned virtual setup in the digital model;
determining one or more force vector directions associated with at least one desired end position of a tooth;
determining a candidate base chamber geometry based on a geometry of a retention portion of an accessory; and
outputting digital data representing the base chamber geometry.

14. The method of claim 13, wherein determining the force vector directions comprises computing force vectors based on the planned virtual setup.

15. The method of claim 13, wherein determining the candidate base chamber geometry comprises computing a base chamber geometry based on a retention portion geometry of the accessory.

16. The method of claim 13, further comprising receiving user input specifying adjustments to the base chamber geometry.

17. The method of claim 13, further comprising receiving user input specifying adjustments to the accessory geometry in the digital model.

18. The method of claim 13, wherein the digital data is output to a fabrication system configured to fabricate a template.

19. The method of claim 13, wherein the template includes an opening that corresponds to an opening of the base chamber geometry.

20. A computer program product comprising a non-transitory computer readable storage medium storing program instructions that when executed by one or more processors cause a computing system to perform the method of claim 13.
